(19) United States
(12) Patent Application Publication
(10) Pub. No.: US 2025/0126680 A1
(43) Pub. Date: Apr. 17, 2025

(54) A METHOD AND SYSTEM FOR HANDLING CALL SETUP PARAMETERS FOR REMOTELY INITIATED CALL

(71) Applicant: Samsung Electronics Co., Ltd., Suwon-si, Gyeonggi-do (KR)

(72) Inventors: Kiran Gurudev KAPALE, Bangalore (IN); Arunprasath RAMAMOORTHY, Bangalore (IN); Basavaraj Jayawant PATTAN, Bangalore (IN)

(21) Appl. No.: 18/294,764

(22) PCT Filed: Aug. 5, 2022
(86) PCT No.: PCT/KR2022/011643

§ 371 Date: Feb. 2, 2024

(30) Foreign Application Priority Data
Aug. 5, 2021 (IN) 202141035426
Jul. 28, 2022 (IN) 2021 41035426

(51) Int. Cl. H04W 76/45; H04W 4/10; H04W 76/10

(52) U.S. Cl. CPC H04W 76/45; H04W 4/10; H04W 76/10

(57) ABSTRACT

The disclosure relates to a 5G or 6G communication system for supporting a higher data transmission rate. In an embodiment, a method for a remotely initiated mission critical push-to-talk (MCPTT) call, by the second MCPTT client, includes receiving, by a second MCPTT client, a remotely initiated MCPTT call request from a first MCPTT client via a MCPTT server to initiate a remote call, notifying, the first MCPTT client, that the second MCPTT client received the remotely initiated MCPTT call request via the MCPTT server and initiating the MCPTT remote call with one of the first MCPTT client and at least one other MCPTT client using the at least one call set up parameter and an indication.

### TECHNICAL FIELD

The present invention generally relates to field of wireless communication, and more particularly to a method and system for managing the call setup related parameters.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

In accordance with some example embodiments of the present subject matter, a method for handling at least one call set up parameter for a remotely initiated Mission Critical Push-To-Talk (MCPTT) call is disclosed. The method includes receiving, by a second MCPTT client, a remotely initiated MCPTT call request from a first MCPTT client via a MCPTT server to initiate a remote call, wherein the remotely initiated MCPTT call request comprises the at least one call set up parameter. The method includes notifying, by the second MCPTT client, the first MCPTT client, that the second MCPTT client received the remotely initiated MCPTT call request via the MCPTT server. The method includes initiating, by the second MCPTT client, the MCPTT remote call with one of the first MCPTT client and at least one other MCPTT client using the at least one call set up parameter and an indication.

In accordance with some example embodiments of the present subject matter, a system for handling at least one call set up parameter for a remotely initiated MCPTT call is disclosed. The system includes receiving, by a second MCPTT client, a remotely initiated MCPTT call request from a first MCPTT client via a MCPTT server to initiate a remote call, wherein the remotely initiated MCPTT call request comprises the at least one call set up parameter. The system includes notifying, by the second MCPTT client, the first MCPTT client, that the second MCPTT client received the remotely initiated MCPTT call request via the MCPTT server. The system includes initiating, by the second MCPTT client, the MCPTT remote call with one of the first MCPTT client and at least one other MCPTT client using the at least one call set up parameter and an indication.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an environment for handling at least one call set up parameter for a remotely initiated MCPTT call, in accordance with an embodiment of the present subject matter;

FIG. 2 illustrates a schematic block diagram depicting the MCPTT server, in accordance with an embodiment of the present subject matter;

FIG. 3 illustrates an operational flow diagram depicting a process for the first MCPTT client requesting the second MCPTT client to initiate a remote MCPTT call, in accordance with an embodiment of the present subject matter;

FIG. 4 illustrates an operational flow diagram depicting a process for using at least one call setup parameter configured at the second MCPTT client while initiating a remote MCPTT call, in accordance with an embodiment of the present subject matter; and

FIG. 5 illustrates a flow diagram depicting a method for handling at least one call set up parameter for a remotely initiated MCPTT call, in accordance with an embodiment of the present subject matter.

FIG. 6 illustrates a diagram illustrating a MCPTT client according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### MODE FOR THE INVENTION

The Mission Critical services would be requiring a feature that allows an authorized user, typically a dispatcher, to cause a remote MCPTT client at MCPTT UE to initiate a MCPTT Private or MCPTT Group call by itself, without its user explicitly initiating the call by depressing the MCPTT switch. The remotely initiated MCPTT services communication procedures are described in the specification 3GPP TS 23.379. The purpose of this feature allows the dispatcher to listen to activities at the location of the remote MCPTT UE to find out what is happening around that MCPTT UE. The typical use cases for this feature are where a user incapacitated, a stolen MCPTT UE undercover operation, discreet surveillance of users or investigations, and could exist depending on the missions of the critical communications users and on legislations. There is a need for the communication to ensure it is set up even in case of resource congestion or to limit disturbance by other services and using required call setup parameters. Hence, it is essential for managing the required call setup parameters information by authorized user/remote MCPTT client/MCPTT server and desired behavior of the call.

There are number of call setup parameters that are required while initiating a call at remote MCPTT client at MCPTT UE such as requested application priority level, commencement mode, functional alias to be used as the called/calling party, requester of remotely initiated call request, indication of the call initiation is due to receiving of remotely initiated call request from authorized user, etc. Without these parameters the essential requirement of the remotely initiated call request feature can't be achieved (e.g. call to be established with highest priority or low priority etc).

Currently there is no mechanisms exists through which the authorized user can specify which call set up parameters to be used in the Private or Group communication which is triggered at the remote MCPTT client at MCPTT UE on receiving the remotely initiated call request.

There is a need to overcome above-mentioned drawbacks.

For promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

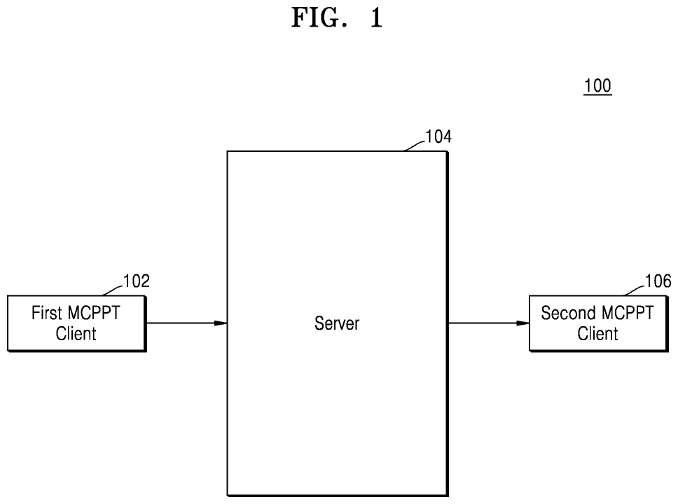

FIG. 1 illustrates an environment 100 for handling at least one call set up parameter for a remotely initiated MCPTT call, in accordance with an embodiment of the present subject matter. The environment 100 may include a first MCPTT client 102, a MCPTT server 104, and a second MCPTT client 106. The environment 100 may further include at least one other MCPTT client. The remotely initiated MCPTT call may interchangeably be referred as a remote MCPTT call. The remote MCPTT call may be between at least two or each of the first MCPTT client 102, the second MCPTT client 106 and the at least one other MCPTT client.

The remote MCPTT call may be one of a remote private call and a remote group call. The remote private call may be placed between the at least two amongst the first MCPTT client 102, the second MCPTT client 106 and the at least one other MCPTT client. Furthermore, the remote group call may be placed between each of the first MCPTT client 102, the second MCPTT client 106 and the at least one other MCPTT client. Moving forward, the first MCPTT client 102, the second MCPTT client 106 and the at least one other MCPTT client may be a User Equipment (UE). Examples of the UE may include, but are not limited to, a smartphone, a tablet, a Personal Computer (PC), and a laptop. The remote MCPTT call may be placed via the MCPTT server 104 and the MCPTT server 104 may be serving as a communication medium between each of first MCPTT client 102, the second MCPTT client 106 and the at least one other MCPTT client.

Continuing with an embodiment of the present subject matter, the second MCPTT client 106 may be configured to receive a remotely initiated MCPTT call request. The remotely initiated MCPTT call request may be transmitted by the first MCPTT client 102 to request the second MCPTT client 106 to initiate the remote call. The remotely initiated MCPTT call request may be received by the second MCPTT client 106 via the MCPTT server 104 as the first MCPTT client 102 may transmit the remotely initiated MCPTT call request via the MCPTT server 104. Further, the remotely initiated MCPTT call request may include at least one call set up parameter.

In response to receiving the remotely initiated MCPTT call request, the second MCPTT client 106 may be configured to acknowledge a receiving of the remotely initiated MCPTT call request. For acknowledging, the second MCPTT client 106 may be configured to notify the first MCPTT client 102 that the second MCPTT client 106 received the remotely initiated MCPTT call request. The second MCPTT client 106 may be configured to notify the first MCPTT client 102 via the MCPTT server 104 such that the second MCPTT client 106 may notify the MCPTT server 104 and the MCPTT server 104 may further communicate with the first MCPTT client 102 to notify about the receiving of the remotely initiated MCPTT call request.

Continuing with the above embodiment, upon notifying the first MCPTT client 102, the second MCPTT client may be configured to initiate the MCPTT remote call. The MCPTT remote call may be initiated with one of the first MCPTT client and the at least one other MCPTT client. The remote MCPTT call may be initiated using the at least one call set up parameter received by the second MCPTT client 106 in the remotely initiated MCPTT call request and an indication related to the second MCPTT client 106.

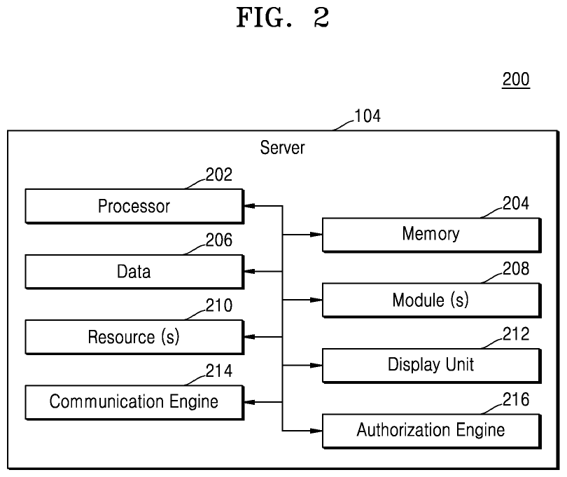

FIG. 2 illustrates a schematic block diagram 200 depicting the MCPTT server 104, in accordance with an embodiment of the present subject matter. The MCPTT server 104 may be a remote server configured to operate as a communication medium between the first MCPTT client 102, the second MCPTT client 106 and the at least one other MCPTT client.

The MCPTT server 104 may include a processor 202, a memory 204, data 206, module(s) 208, resource(s) 210, a display unit 212, a communication engine 214, an authorization engine 216.

In an embodiment, the processor 202, the memory 204, the data 206, the module(s) 208, the resource(s) 210, the display unit 212, the communication engine 214, and the authorization engine 216.

As would be appreciated, the MCPTT server 104, may be understood as one or more of a hardware, a software, a logic-based program, a configurable hardware, and the like. In an example, the processor 202 may be a single processing unit or a number of units, all of which could include multiple computing units. The processor 202 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 202 may be configured to fetch and/or execute computer-readable instructions and/or data stored in the memory 204.

In an example, the memory 204 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The memory 204 may include the data 206. The data 206 serves, amongst other things, as a repository for storing data processed, received, and generated by one or more of the processor 202, the memory 204, the module(s) 208, the resource(s) 210, the display unit 212, the communication engine 214, and the authorization engine 216.

The module(s) 208, amongst other things, may include routines, programs, objects, components, data structures, etc., which perform particular tasks or implement data types. The module(s) 208 may also be implemented as, signal processor(s), state machine(s), logic circuitries, and/or any other device or component that manipulate signals based on operational instructions.

Further, the module(s) 208 may be implemented in hardware, as instructions executed by at least one processing unit, e.g., processor 202, or by a combination thereof. The processing unit may be a general-purpose processor that executes instructions to cause the general-purpose processor to perform operations or, the processing unit may be dedicated to performing the required functions. In another aspect of the present disclosure, the module(s) 208 may be machine-readable instructions (software) which, when executed by a processor/processing unit, may perform any of the described functionalities.

In some example embodiments, the module(s) 208 may be machine-readable instructions (software) which, when executed by a processor 202/processing unit, perform any of the described functionalities.

The resource(s) 210 may be physical and/or virtual components of the MCPTT server 104 that provide inherent capabilities and/or contribute towards the performance of the MCPTT server 104. Examples of the resource(s) 210 may include, but are not limited to, a memory (e.g., the memory 204), a power unit (e.g., a battery), a display unit (e.g., the display unit 212) etc. The resource(s) 210 may include a power unit/battery unit, a network unit, etc., in addition to the processor 202, and the memory 204.

The display unit 212 may display various types of information (for example, media contents, multimedia data, text data, etc.) to the MCPTT server 104. The display unit 212 may include, but is not limited to, a liquid crystal display (LCD), a light-emitting diode (LED) display, an organic LED (OLED) display, a plasma cell display, an electronic ink array display, an electronic paper display, a flexible LCD, a flexible electrochromic display, and/or a flexible electrowetting display.

Continuing with the above embodiment, the communication engine 214 may be configured to receive a remotely initiated MCPTT call request from the first MCPTT client 102. The first MCPTT client 102 may transmit the remotely initiated MCPTT call request to the MCPTT server 104 with an intention of the remotely initiated MCPTT call request being forwarded to the second MCPTT client by the MCPTT server 104. The remotely initiated MCPTT call request may be transmitted to the second MCPTT client to request the second MCPTT client to initiate a remote MCPTT call with one of the first MCPTT client 102 and the at least one other MCPTT client. The remote MCPTT call may be one of a remote private call and a remote group call.

Further, the remotely initiated MCPTT call request may include at least one call set up parameter. Examples of the call set up parameters may include, but are not limited to, a requested application priority level, a requested commencement mode, a remotely initiated-call request indicator, a requester of the remotely initiated MCPTT call request, a functional alias to be used as the first MCPTT client 102 and the second MCPTT client 106. The function alias may be activated prior to utilizing by the first MCPTT client 102 and the second MCPTT client 106. In an embodiment of the present subject matter, the second MCPTT client 106 may be including the at least call set up parameter configured at the second MCPTT client 106 prior to receiving the remotely initiated MCPTT call request.

Continuing with the above embodiment, in response to receiving the remotely initiated MCPTT call request by the communication engine 214, the authorization engine 216 may be configured to perform a verification of the first MCPTT client 102. The verification may be performed to authorize the first MCPTT client 102. Moving forward, in response to a successful authorization of the first MCPTT client 102, the communication engine 214 may be configured to transmit the remotely initiated MCPTT call request to the second MCPTT client 106.

Subsequent to transmitting the remotely initiated MCPTT call request to the second MCPTT client 106, the communication engine 214 may be configured to receive a notification from the second MCPTT client 106. The notification may further be needed to be transmitted to the first MCPTT client 102. The notification may be an acknowledgement by the second MCPTT client 106 that the remotely initiated MCPTT client request is received by the second MCPTT client 106. In response, the communication engine 214 may be configured to transmit the notification to the first MCPTT client 102.

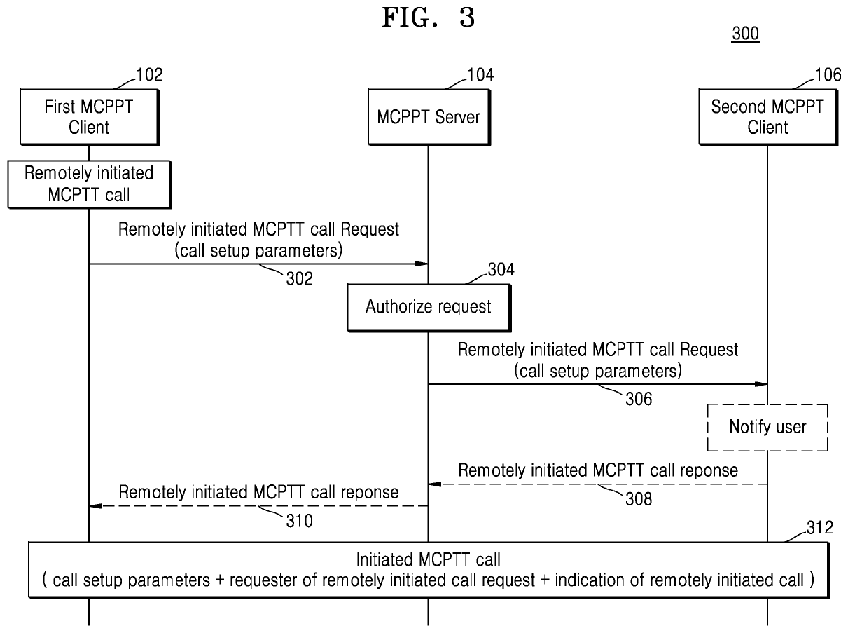

FIG. 3 illustrates an operational flow diagram depicting a process for the first MCPTT client 102 requesting the second MCPTT client 106 to initiate a remote MCPTT call, in accordance with an embodiment of the present subject matter. The first MCPTT client 102 may be configured to request the second MCPTT client 106 by sending a remotely initiated MCPTT call request via the MCPTT server 104 as referred in the FIG. 1 and the FIG. 2. The first MCPTT client 102 may be requesting the second MCPTT client 106 to initiate the remote MCPTT call with one or more of the first MCPT client and the at least one other MCPTT client.

Subsequently, the remote MCPTT call may be one of a remote private call and a remote group call. In an embodiment of the present subject matter, the first MCPTT client 102 may be requesting the second MCPTT client 106 to initiate a remote private call with one of the first MCPTT client 102 and the at least one other MCPTT client. In another embodiment of the present subject matter, the first MCPTT client 102 may be requesting the second MCPTT client 106 to initiate the remote group call with one of the first MCPTT client 102, and the at least one other MCPTT client, and the at least other MCPTT client.

Further, examples of the at least one call set up parameter may include, but are not limited to, a requested application priority level, a requested commencement mode, a remotely initiated-call request indicator, a requester of the remotely initiated MCPTT call request, a functional alias to be used as the first MCPTT client 102 and the second MCPTT client 106. The function alias may be activated prior to utilizing by the first MCPTT client 102 and the second MCPTT client 106.

At step 302, the process 300 may include transmitting the remotely initiated MCPTT call request to the MCPTT server 104. The remotely initiated MCPTT call request may include the at least one call set up parameter. The remotely initiated MCPTT call request may be transmitted by the first MCPTT client 102. The MCPTT server 104 may be configured to receive the remotely initiated MCPTT call request. Subsequently, Table 1 depicts the at least one call set up parameter for the remotely initiated MCPTT call request from the first MCPTT client 102 to the MCPTT server 104 and from the MCPTT server 104 to the second MCPTT client 106.

TABLE 1
remotely initiated MCPTT call request information elements

| Information Element | Status | Description |
|---|---|---|
| MCPTT ID | M | The MCPTT ID of the called party (remote) |
| MCPTT ID | M | The MCPTT ID of the calling party |
| Notification to remote user of | M | Use to determine whether the called party (remote) |
| remotely initiated call | | receives any indication of the remotely initiated |
| | | MCPTT call. |
| MCPTT ID | O (NOTE 1) | For a remotely initiated MCPTT private call the |
| | | MCPTT User ID to be called |
| MCPTT Group ID | O (NOTE 1) | For a remotely initiated |
| | | MCPTT group call to use. |
| Functional alias | O (NOTE 1) | For a remotely initiated MCPTT private call, the |
| | | functional alias to be used by the called party |
| | | (remote) as a target of the call while initiating a call |
| | | requested by a received remotely initiated call |
| Functional alias (see NOTE 2) | O | For a remotely initiated MCPTT private call or |
| | | MCPTT group call, the functional alias to be used by |
| | | the called party (remote) as an initiator of the call |
| | | while initiating a call requested by a received |
| | | remotely initiated call |
| Requested commencement mode | O | For a remotely initiated MCPTT private call, |
| | | requested commencement mode to be used by the |
| | | called party (remote) as a commencement mode |
| | | while initiating a call requested by a received |
| | | remotely initiated call. The values could be force- |
| | | auto-mode, auto-mode and manual-mode |
| Requested priority | O | For a remotely initiated MCPTT private call or |
| | | MCPTT group call, requested priority level to be |
| | | used by the called party (remote) as an application- |
| | | level priority while initiating a call requested by a |
| | | received remotely initiated call |

(NOTE 1):
One and only one of these shall be present.
(NOTE 2):
If the called party(target) to be used is functional alias then only functional alias for calling party(initiator) to be used.

At step 304, the process 300 may include checking by the MCPTT server 104 whether the first MCPTT client 102 is authorized to request the second MCPTT client 106 to initiate the remote MCPTT call upon receiving the remotely initiated MCPTT call request intended to be transmitted to the second MCPTT client 106 from the first MCPTT client 102.

At step 306, the process 300 may include transmitting by the MCPTT server 104, the remotely initiated MCPTT call request along with the at least one call set up parameter to the second MCPTT client 106 as intended by the first MCPTT client 102 at the time of transmitting the remotely initiated MCPTT call request to the MCPTT server 104. The remotely initiated MCPTT call request may be transmitted by the MCPTT server 104 in response to determining that the first MCPTT client 102 is authorized to request the second MCPTT client 106 to initiate the remote call. Continuing with the above embodiment, the second MCPTT client 106 may be configured to receive the remotely initiated MCPTT call request from the MCPTT server 104.

At step 308, the process 300 may include notifying the server 304 by the second MCPTT client 106 that the remotely initiated MCPTT call request is received by the second MCPTT client 106. In an embodiment, the MCPTT server 104 may be notified by transmitting a remotely initiated MCPTT call response by the second MCPTT client 106 to the MCPTT server 104.

At step 310, the process 300 may include notifying the first MCPTT client 102, by the MCPTT server 104 that the remotely initiated MCPTT call request is received by the second MCPTT client 106. The first MCPTT client 102 may be notified by the MCPTT server 104 by transmitting the remotely initiated MCPTT call response to the first MCPTT client 102.

At step 312, the process 300 may include initiating by the second MCPTT call the remote MCPTT call with one or more of the first MCPT client and the at least one other MCPTT client. In an embodiment, the second MCPTT client 106 may initiate the remote private call with one of the first MCPTT client 102 and the at least one other client as requested in the remotely initiated MCPTT call request. In another embodiment, the second MCPTT client 106 may initiate the remote group call with one of the first MCPTT client 102, and the at least one other CMPTT client, and the at least one other MCPTT client as requested in the remotely initiated MCPTT call request. The remote MCPTT call may be initiated by using the at least one call set up parameter transmitted by the first MCPTT client 102 and an indication related to the second MCPTT client 106. The indication may indicate indicates whether the initiation of the MCPTT remote call is due to receiving of the remotely initiated MCPTT call request from the first MCPTT client 102. In an embodiment of the present subject matter, the steps 308 and 310 may not occur as the remote call initiated by the second MCPTT client 106 may be identified as an acknowledgment that the second MCPTT client 106 received the remotely initiated MCPTT call request. In another embodiment of the present subject matter, the steps 308 and 310 may occur after the step 312.

In an embodiment of the present subject matter, the process 300 may disclose a prearranged group call procedure where the first MCPTT client 102 may be initiating an MCPTT group call also referred as the remote group call with a unicast signaling for communicating with the affiliated MCPTT members of a group such as the second MCPTT client 106 and the at least one other MCPTT client. If the initiating of the MCPTT group call is due to receiving of remotely initiated MCPTT call request and the at least one call setup parameter is shared in the remotely initiated MCPTT call request, then the at least one call setup parameter is used while initiating the MCPTT group call.

In another embodiment of the present subject matter, the process 300 may disclose a private call procedure where the first MCPTT client 102 may be initiating an MCPTT private call also referred as the remote group call with a unicast signaling for communicating with another MCPTT user such as the second MCPTT client 106, with or without a floor control enabled, and a commencement mode as automatic or manual. If the initiating of the MCPTT private call is due to receiving of the remotely initiated MCPTT call request and the at least one call setup parameter is shared in the remotely initiated MCPTT call request, then the at least one call setup parameter is used while initiating the MCPTT private call.

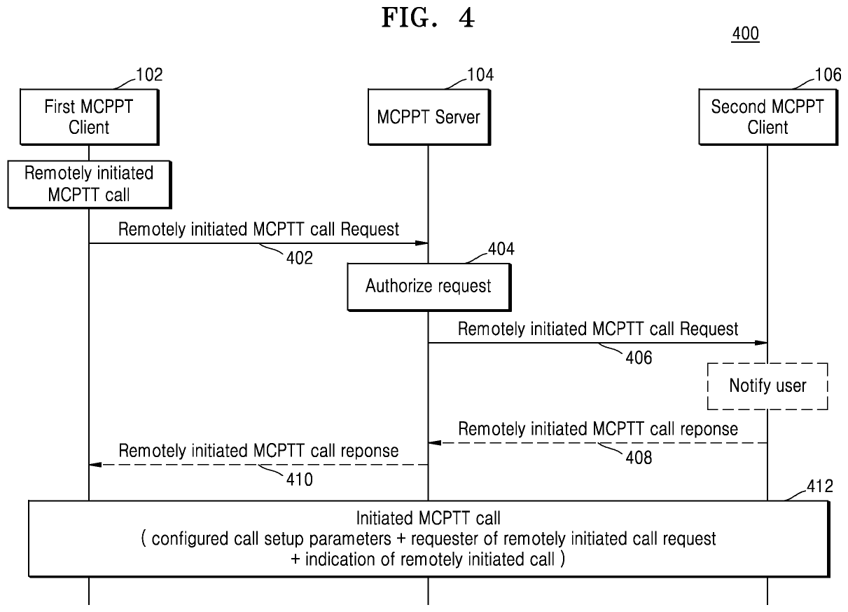

FIG. 4 illustrates an operational flow diagram depicting a process 400 for using at least one call setup parameter configured at the second MCPTT client 106 while initiating a remote MCPTT call, in accordance with an embodiment of the present subject matter. The second MCPTT client 106 may be configured with the at least one call setup parameter required at the second MCPTT client 106. On receiving of a remotely initiated MCPTT call request from an authorized user such as the first MCPTT client 102, the second MCPTT client 106, initiates a call using the configured at least one call setup parameter received from the first MCPTT client 102. The Second MCPTT client 106 uses the at least one call set up parameter and an indication of whether the call initiation is due to receiving of remotely initiated MCPTT call request from the authorized user while initiating the remote MCPTT call.

At step 402, the process 400 may include transmitting the remotely initiated MCPTT call request to the MCPTT server 104. The remotely initiated MCPTT call request may be transmitted by the first MCPTT client 102. The MCPTT server 104 may be configured to receive the remotely initiated MCPTT call request.

At step 404, the process 400 may include checking by the MCPTT server 104 whether the first MCPTT client 102 is authorized to request the second MCPTT client 106 to initiate the remote MCPTT call upon receiving the remotely initiated MCPTT call request intended to be transmitted to the second MCPTT client 106 from the first MCPTT client 102.

At step 406, the process 400 may include transmitting by the MCPTT server 104, the remotely initiated MCPTT call request to the second MCPTT client 106 as intended by the first MCPTT client 102 at the time of transmitting the remotely initiated MCPTT call request to the MCPTT server 104. The remotely initiated MCPTT call request may be transmitted by the MCPTT server 104 in response to determining that the first MCPTT client 102 is authorized to request the second MCPTT client 106 to initiate the remote call. Continuing with the above embodiment, the second MCPTT client 106 may be configured to receive the remotely initiated MCPTT call request from the MCPTT server 104.

At step 408, the process 400 may include notifying the server 404 by the second MCPTT client 106 that the remotely initiated MCPTT call request is received by the second MCPTT client 106. In an embodiment, the MCPTT server 104 may be notified by transmitting a remotely initiated MCPTT call response by the second MCPTT client 106 to the MCPTT server 104.

At step 410, the process 400 may include notifying the first MCPTT client 102, by the MCPTT server 104 that the remotely initiated MCPTT call request is received by the second MCPTT client 106. The first MCPTT client 102 may be notified by the MCPTT server 104 by transmitting the remotely initiated MCPTT call response to the first MCPTT client 102.

At step 412, the process 400 may include initiating by the second MCPTT call the remote MCPTT call with one or more of the first MCPT client and the at least one other MCPTT client with an implicit floor request. In an embodiment, the second MCPTT client 106 may initiate the remote private call with one of the first MCPTT client 102 and the at least one other client as requested in the remotely initiated MCPTT call request. In another embodiment, the second MCPTT client 106 may initiate the remote group call with one of the first MCPTT client 102, and the at least one other CMPTT client, and the at least one other MCPTT client as requested in the remotely initiated MCPTT call request. The remote MCPTT call may be initiated by using the at least one call set up parameter configured at the second MCPTT client 106, and an indication related to the second MCPTT client 106. The indication may indicate indicates whether the initiation of the MCPTT remote call is due to receiving of the remotely initiated MCPTT call request from the first MCPTT client 102. The at least one call set up parameter configured at the second MCPTT client 106 may require configuration information such as MCPTT user profile data (on and off network) as depicted in table 2 below.

TABLE 2
MCPTT user profile data (on and off network)

| | | | | Config- | |
|---|---|---|---|---|---|
| | | | | uration | |
| | | | | manage- | MCPTT |
| | | MCPTT | MCPTT | ment | user |
| Reference | Parameter description | UE | Server | server | database |
| 3GPP TS 22.280 | Functional aliases which can be | Y | Y | Y | Y |
| | used as called party on receiving a | | | | |
| | remotely initiated MCPTT call | | | | |
| | request for MCPTT private call | | | | |
| 3GPP TS 22.280 | Functional aliases which can be | Y | Y | Y | Y |
| | used as calling party on receiving | | | | |
| | a remotely initiated MCPTT call | | | | |
| | request for MCPTT private call | | | | |
| | and MCPTT group call | | | | |

Continuing with the above embodiment, the present subject matter may further include configuration information required for the at least one call setup parameter while initiating the remote MCPTT call on receiving the remotely initiated MCPTT call request that contain in MCPTT service configuration required to support a use of on-network/off-network MCPTT service.

TABLE 3
MCPTT service configuration data (on and off network)

| | | | | Configuration |
|---|---|---|---|---|
| | | MCPTT | MCPTT | management |
| Reference | Parameter description | UE | Server | server |
| 3GPP TS 22.280 | For a remotely initiated | Y | Y | Y |
| | MCPTT private call, An | | | |
| | indication that is included | | | |
| | requesting a particular | | | |
| | commencement mode for this | | | |
| | call | | | |
| 3GPP TS 22.280 | For a remotely initiated | Y | Y | Y |
| | MCPTT private call or | | | |
| | MCPTT group call, An | | | |
| | indication that is included | | | |
| | requesting a particular | | | |
| | application priority level for | | | |
| | this call | | | |

In another embodiment, the present subject matter may further include a method for using the at least one call setup parameter configured at the MCPTT server 104. The MCPTT server 104 may be configured with the required at least one call setup parameter for the remote MCPTT call. On receiving the remotely initiated MCPTT call request from the first MCPTT client 102, the MCPTT server 104 may apply the relevant call setup parameters from the at least one call set up parameter for establishing a the MCPTT remote call.

Table 4 depicts the configuration information required for the at least one call setup parameter while initiating the remote MCPTT call on receiving the remotely initiated MCPTT call request that contain in the MCPTT service configuration required to support the use of on-network/off-network MCPTT service.

TABLE 4
MCPTT service configuration data (on and off network)

| | | | | Configuration |
|---|---|---|---|---|
| | | MCPTT | MCPTT | management |
| Reference | Parameter description | UE | Server | server |
| 3GPP TS 22.280 | For a remotely initiated MCPTT | N | Y | Y |
| | private call, an indication that is | | | |
| | included requesting a particular | | | |
| | commencement mode for this | | | |
| | call | | | |
| 3GPP TS 22.280 | For a remotely initiated MCPTT | N | Y | Y |
| | private call or MCPTT group | | | |
| | call, An indication that is | | | |
| | included requesting a particular | | | |
| | application priority level for this | | | |
| | call | | | |

Alternatively, the configuration may be defined in the MCPTT user profile configuration data as depicted in table 5.

TABLE 5
MCPTT user profile data (on and off network)

| | | | | | MCPTT |
|---|---|---|---|---|---|
| | | | | Configuration | user |
| | | MCPTT | MCPTT | management | data- |
| Reference | Parameter description | UE | Server | server | base |
| 3GPP TS 22.280 | For a remotely initiated | Y | Y | Y | N |
| | MCPTT private call, An | | | | |
| | indication that is included | | | | |
| | requesting a particular | | | | |
| | commencement mode for this | | | | |
| | call | | | | |
| 3GPP TS 22.280 | For a remotely initiated | Y | Y | Y | N |
| | MCPTT private call or | | | | |
| | MCPTT group call, An | | | | |
| | indication that is included | | | | |
| | requesting a particular | | | | |
| | application priority level for | | | | |
| | this call | | | | |

If the received call initiation request at MCX server for an MCPTT group call is due to receiving of remotely initiated MCPTT call request at MCX client at MCPTT UE then the MCPTT server applies the call setup parameters while establishing a call. The MCPTT group call may include the additional information such as requester of the remotely initiated MCPTT call request and indication of whether the call initiation is due to receiving of remotely initiated MCPTT call request from authorized user.

The private call procedure focuses on the case where an MCPTT client is initiating an MCPTT private call with unicast signaling for communicating with another MCPTT user, with or without floor control enabled, and commencement mode as automatic or manual.

If the received call initiation request at MCX server for an MCPTT private call is due to receiving of remotely initiated MCPTT call request at MCX client, then the MCX server applies the call setup parameters while establishing a call. The MCPTT private call may include the additional information such as requester of the remotely initiated MCPTT call request and indication of whether the call initiation is due to receiving of remotely initiated MCPTT call request from authorized user.

Table 6 depicts the information flow MCPTT private call request from the MCPTT client to the MCPTT server.

TABLE 6
MCPTT private call request (MCPTT client to MCPTT server) information elements

| Information Element | Status | Description |
|---|---|---|
| MCPTT ID | M | The MCPTT ID of the calling party |
| Functional alias | O | The functional alias of the calling party |
| MCPTT ID (see NOTE) | O | The MCPTT ID of the called party |
| Functional alias (see NOTE) | O | The functional alias of the called party |
| IJse floor control indication | M | This element indicates whether floor control will be used |
| | | for the private call. |
| SDP offer | O | Media parameters of MCPTT client. |
| Requested commencement mode | O | An indication that is included if the user is requesting a |
| | | particular commencement mode |
| Implicit floor request | O | An indication that the user is also requesting the floor. |
| Location information | O | Location of the calling party |
| Requested priority | O | Application priority level requested for this call |
| Transfer indicator | O | Indicates that the MCPTT private call request is a result |
| | | of a call transfer (true/false) |
| Forwarding indicator | O | Indicates that the MCPTT private call request is a result |
| | | of a call forwarding. (true/false) |
| MCPTT ID | O | The MCPTT ID of the authorized user who has requested |
| | | for remotely initiated MCPTT call request and must be |
| | | present for remotely initiated call |
| Remotely initiated MCPTT call | O | Indicates that the MCPTT private call request is a result |
| request indicator | | of receiving of a remotely initiated MCPTT call request |
| | | (true/false) and must be present for remotely initiated call |

NOTE:
At least one identity must be present.

Table 7 depicts an information flow for the remotely initiated MCPTT call request for the remote private call from an MCPTT server to an MCPTT server. Information may be the at least one call set up parameter.

TABLE 7
MCPTT private call request (MCPTT server to MCPTT server) information elements

| Information Element | Status | Description |
|---|---|---|
| MCPTT ID | M | The MCPTT ID of the calling party |
| Functional alias | O | The functional alias of the calling party |
| MCPTT ID | M | The MCPTT ID of the called party |
| Functional alias | O | The functional alias of the called party |
| Use floor control indication | M | This element indicates whether floor |
| | | control will be used for the private call. |
| SDP offer | M | Media parameters of MCPTT client. |
| Requested commencement mode | O | An indication of the commencement |
| | | mode to be used. |
| Implicit floor request | O | An indication that the user is also |
| | | requesting the floor. |
| Requested priority | O | Priority level requested for the call. |
| Location information | O | Location of the calling party |
| MCPTT ID | O | The MCPTT ID of the authorized user |
| | | who has requested for remotely initiated |
| | | MCPTT call request and must be |
| | | present for remotely initiated call |
| Remotely initiated MCPTT call | O | Indicates that the MCPTT private call |
| request indicator | | request is a result of receiving of a |
| | | remotely initiated MCPTT call request |
| | | (true/false) and must be present for |
| | | remotely initiated call |

Table 8 depicts the information flow for the remotely initiated MCPTT call request for the remote private call from the MCPTT server to a MCPTT client such as the second MCPT client.

TABLE 8
depicts MCPTT private call request (MCPTT server to MCPTT client) information elements

| Information Element | Status | Description |
|---|---|---|
| MCPTT ID | M | The MCPTT ID of the calling party |
| Functional alias | O | The functional alias of the calling party |
| MCPTT ID | M | The MCPTT ID of the called party |
| Functional alias | O | The functional alias of the called party |
| Use floor control indication | M | This element indicates whether floor control |
| | | will be used for the private call. |
| SDP offer | M | Media parameters of MCPTT client. |
| Requested commencement | O | An indication of the commencement mode to |
| mode | | be used. |
| Implicit floor request | O | An indication that the user is also requesting the |
| | | floor. |
| MCPTT ID | O | The MCPTT ID of the authorized user who has |
| | | requested for remotely initiated MCPTT call |
| | | request and must be present for remotely |
| | | initiated call |
| Remotely initiated MCPTT | O | Indicates that the MCPTT private call request |
| call request indicator | | is a result of receiving of a remotely initiated |
| | | MCPTT call request (true/false) and must be |
| | | present for remotely initiated call |

Table 9 depicts information flow group call request from the MCPTT client to the MCPTT server.

TABLE 9
depicts group call request information elements

| Information Element | Status | Description |
|---|---|---|
| MCPTT ID | M | The MCPTT ID of the calling party |
| Functional alias | O | The functional alias of the calling party |
| MCPTT group ID (NOTE) | O | The MCPTT group ID of the group on which |
| | | the call is requested |
| SDP offer | M | Media parameters of MCPTT clients |
| Implicit floor request | O | When originating client requests the floor, |
| | | this element shall be included |
| Broadcast indicator | O | Indicates that the group call request is for a |
| | | broadcast group call |
| MCPTT ID list | O | The MCPTT ID of users being invited to the |
| | | temporary group call - user regroup |
| Temporary group indicator | O | Indicates that the group call request is for a |
| | | temporary group call - user regroup |
| Location information | O | Location of the calling party. |
| Requested priority | O | Application priority level requested for this |
| | | call |
| MCPTT ID | O | The MCPTT ID of the authorized user who |
| | | has requested for remotely initiated MCPTT |
| | | call request and must be present for remotely |
| | | initiated call |
| Remotely initiated MCPTT call | O | Indicates that the MCPTT private call request |
| request indicator | | is a result of receiving of a remotely initiated |
| | | MCPTT call request (true/false) and must be |
| | | present for remotely initiated call |

NOTE:
the MCPTT group ID shall not be present for the temporary group call - user regroup.

### Group Call Request (MCPTT Server-MCPTT Server)

Table 10 describes the information flow group call request between the MCPTT servers.

TABLE 10
depicts Group call request information elements

| Information Element | Status | Description |
|---|---|---|
| MCPTT ID | M | The MCPTT ID of the calling party |
| Functional alias | O | The functional alias of the calling party |
| MCPTT group ID | M | The MCPTT group ID of the group on which the call |
| | | is initiated |
| SDP offer | M | Media parameters of MCPTT server |
| Broadcast indicator | O | Indicates that the group call request is for a broadcast |
| | | group call |
| Implicit floor request | O | Indicates that the originating client requests the floor. |
| (NOTE) | | |
| Requested priority | O | Priority level requested for the call. |
| Location information | O | Location of the calling party |
| MCPTT ID | O | The MCPTT ID of the authorized user who has |
| | | requested for remotely initiated MCPTT call request |
| | | and must be present for remotely initiated call |
| Remotely initiated | O | Indicates that the MCPTT private call request is a |
| MCPTT call request | | result of receiving of a remotely initiated MCPTT call |
| indicator | | request (true/false) and must be present for remotely |
| | | initiated call |

NOTE:
This element shall be included only when the originating client requests the floor.

Table 11 describes the information flow group call request from the MCPTT server to the MCPTT client.

TABLE 11
depicts group call request information elements

| Information Element | Status | Description |
|---|---|---|
| MCPTT ID | M | The MCPTT ID of the calling party |
| Functional alias | O | The functional alias of the calling party |
| MCPTT group ID | M | The MCPTT group ID of the group on which |
| | | the call is initiated |
| SDP offer | M | Media parameters of MCPTT server |
| Broadcast indicator | O | Indicates that the group call request is for a |
| | | broadcast group call |
| Temporary group | O | Indicates that the group call request is for a |
| indicator | | temporary group call performed by user |
| | | regroup |
| MCPTT ID | O | The MCPTT ID of the authorized user who |
| | | has requested for remotely initiated MCPTT |
| | | call request and must be present for remotely |
| | | initiated call |
| Remotely initiated | O | Indicates that the MCPTT private call request |
| MCPTT call request | | is a result of receiving of a remotely initiated |
| indicator | | MCPTT call request (true/false) and must be |
| | | present for remotely initiated call |

The present subject matter includes the detailed flow for the remotely initiated private call initiation request procedures as follows. Upon receiving a request from a requesting MCPTT user such as the first MCPTT client 102 to send a remotely initiated private call request to another remote MCPTT user such as the second MCPTT client 106 to originate a private call to an identified MCPTT user, the MCPTT client:
A. shall validate that the requesting MCPTT user is not authorized to initiate a remotely initiated private call request to the remote MCPTT user and if not authorized shall skip the rest of the steps of the present clause;
B. shall generate a SIP MESSAGE request in accordance with 3GPP TS 24.229 and IETF RFC 3428 with the following clarifications such as the SIP MESSAGE request shall/may include required header field and corresponding values, such as P-Preferred-Service, Accept-Contact, P-Preferred-Identity, Request-URI and MIME resource-lists body;
C. shall include an application/vnd.3gpp.mcptt-info+xml MIME body as specified in clause F.1 with the <mcpttinfo> element containing the <mcptt-Params> element with the <anyExt> element containing the <request-type> element set to a value of “remotely-initiated-private-call-request”, the <mcptt-called-party-id> element set to the MCPTT ID of the identified MCPTT user of the remotely initiated private call, the <notify-remote-user> element set to a value of “true” if the requesting MCPTT user has indicated that the remote MCPTT user be notified of the remotely initiated private call request, or the <notify-remote-user> element set to a value of “false” if the requesting MCPTT user has indicated that the remote MCPTT user not be notified of the remotely initiated private call request, <remotely-initiated-call-initiator-functional-alias-URI> element set to a value of the functional alias to be used by the remote MCPTT user as an initiator of the call while initiating a call requested by a received remotely initiated MCPTT call request, <remotely-initiated-call-target-functional-alias-URI> element set to a value of the functional alias to be used by the remote MCPTT user as a target of the call while initiating a call requested by a received remotely initiated MCPTT call request, <remotely-initiated-call-application-level-priority> element set to a value of the namespace and priority values as specified in IETF RFC 8101 and MCPTT service configuration document (see the service configuration document in 3GPP TS 24.484) to be used by the remote MCPTT user to request an application level priority for a call while initiating a call requested by a received remotely initiated MCPTT call request; and <remotely-initiated-call-commencement-mode> element set:
1. to a value of “force-auto-mode”, if the requesting MCPTT user has indicated that the remote MCPTT user to request the force of automatic commencement mode at the invited MCPTT client while initiating a call requested by a received remotely initiated MCPTT call request;
2. to a value of “auto-mode”, if the requesting MCPTT user has indicated that the remote MCPTT user to request the automatic commencement mode at the invited MCPTT client while initiating a call requested by a received remotely initiated MCPTT call request; or
3. to a value of “manual-mode”, if the requesting MCPTT user has indicated that the remote MCPTT user to request the manual commencement mode at the invited MCPTT client while initiating a call requested by a received remotely initiated MCPTT call request;
D. shall send the SIP MESSAGE request towards the MCPTT server according to rules and procedures of 3GPP TS 24.229.

### Remote Client Procedures for Handling Remotely Initiated Private Call Request

Upon receiving a “SIP MESSAGE request for remotely initiated private call request for terminating client”, the MCPTT client shall extract the MCPTT ID of the identified MCPTT user from the <mcptt-called-party-id> element contained in the <anyExt> element of the <mcptt-Params> element of the <mcpttinfo> element contained in the application/vnd.3gpp.mcptt-info+xml MIME body contained in the received SIP MESSAGE request and any other actions based on received <notify-remote-user> element. if according to local policy on-demand sessions are to be used for remotely initiated private calls, shall invoke the procedures of clause 11.1.1.2.1.1 of 3GPP TS 24.379 to originate an MCPTT private call to the identified MCPTT user with the following clarifications:
A. if the <remotely-initiated-call-initiator-functional-alias-URI> element contained in the <anyExt> element of the <mcptt-Params> element of the <mcpttinfo> element contained in the application/vnd.3gpp.mcptt-info+xml MIME body contained in the received SIP MESSAGE request is set to value of functional alias URI, may include in the initial SIP INVITE request as used functional alias (i.e. calling party functional alias), if the received functional alias activated for an MCPTT ID of the identified MCPTT user;
B. if the <remotely-initiated-call-target-functional-alias-URI> element contained in the <anyExt> element of the <mcptt-Params> element of the <mcpttinfo> element contained in the application/vnd.3gpp.mcptt-info+xml MIME body contained in the received SIP MESSAGE request is set to value of functional alias URI, may include in the initial SIP INVITE request as a functional alias to be called (i.e. called party functional alias), if the received functional alias is authorized to be used by an identified MCPTT user;
C. if the <remotely-initiated-call-application-level-priority> element contained in the <anyExt> element of the <mcptt-Params> element of the <mcpttinfo> element contained in the application/vnd.3gpp.mcptt-info+xml MIME body contained in the received SIP MESSAGE request is set to a value of the namespace and priority value, may include in the initial SIP INVITE request as a requested resource priority as specified in IETF RFC 8101 and MCPTT service configuration document (see the service configuration document in 3GPP TS 24.484); and
D. if the <remotely-initiated-call-commencement-mode> element contained in the <anyExt> element of the <mcptt-Params> element of the <mcpttinfo> element contained in the application/vnd.3gpp.mcptt-info+xml MIME body contained in the received SIP MESSAGE request is set to a value of “force-auto-mode”, may include in the initial SIP INVITE request to privileged answer mode with auto commencement mode to force of automatic commencement mode at the invited MCPTT client, or to a value of “auto-mode”, may include in the initial SIP INVITE request to answer mode with auto commencement mode to request automatic commencement mode at the invited MCPTT client, or to a value of “manual-mode”, may include in the initial SIP INVITE request to answer mode with manual commencement mode to request manual commencement mode at the invited MCPTT client.

If according to local policy pre-established sessions are to be used for remotely initiated private calls and a pre-established session is available, shall invoke the procedures of clause 11.1.1.2.2.1 of 3GPP TS 24.379 to originate an MCPTT private call to the identified MCPTT user with the following clarifications:
a) if the <remotely-initiated-call-initiator-functional-alias-URI> element contained in the <anyExt> element of the <mcptt-Params> element of the <mcpttinfo> element contained in the application/vnd.3gpp.mcptt-info+xml MIME body contained in the received SIP MESSAGE request is set to value of functional alias URI, may include in the initial SIP REFER request as used functional alias (i.e. calling party functional alias), if the received functional alias activated for an MCPTT ID of the identified MCPTT user;
b) if the <remotely-initiated-call-target-functional-alias-URI> element contained in the <anyExt> element of the <mcptt-Params> element of the <mcpttinfo> element contained in the application/vnd.3gpp.mcptt-info+xml MIME body contained in the received SIP MESSAGE request is set to value of functional alias URI, may include in the initial SIP REFER request as a functional alias to be called (i.e. called party functional alias), if the received functional alias is authorized to be used by an identified MCPTT user;
c) if the <remotely-initiated-call-application-level-priority> element contained in the <anyExt> element of the <mcptt-Params> element of the <mcpttinfo> element contained in the application/vnd.3gpp.mcptt-info+xml MIME body contained in the received SIP MESSAGE request is set to a value of the namespace and priority value, may include in the initial SIP REFER request as a requested resource priority as specified in IETF RFC 8101 and MCPTT service configuration document (see the service configuration document in 3GPP TS 24.484); and
d) if the <remotely-initiated-call-commencement-mode> element contained in the <anyExt> element of the <mcptt-Params> element of the <mcpttinfo> element contained in the application/vnd.3gpp.mcptt-info+xml MIME body contained in the received SIP MESSAGE request is set:
1. to value of “force-auto-mode”, may include in the initial SIP REFER request to privileged answer mode with auto commencement mode to force of automatic commencement mode at the invited MCPTT client;
2. to value of “auto-mode”, may include in the initial SIP REFER request to answer mode with auto commencement mode to request automatic commencement mode at the invited MCPTT client; or
3. to value of “manual-mode”, may include in the initial SIP REFER request to answer mode with manual commencement mode to request manual commencement mode at the invited MCPTT client.

### Remotely Initiated Group Call Initiation Request Procedures

Upon receiving a request from the requesting MCPTT user to send a remotely initiated group call request to the remote MCPTT user for a targeted MCPTT group, the MCPTT client:
1) shall validate that the requesting MCPTT user is not authorized to initiate a remotely initiated group call request to the remote MCPTT user and if not authorized shall skip the rest of the steps of the present clause;
2) shall generate a SIP MESSAGE request in accordance with 3GPP TS 24.229 and IETF RFC 3428 with the following clarifications:
a. shall/may include required header field and corresponding values, such as P-Preferred-Service, Accept-Contact, P-Preferred-Identity, Request-URI and MIME resource-lists body;
b. shall include an application/vnd.3gpp.mcptt-info+xml MIME body as specified in clause F.1 of 3GPP TS 24.379 with the <mcpttinfo> element containing the <mcptt-Params> element with the <anyExt> element containing:
1. the <mcptt-request-uri> set to the MCPTT group identity of the targeted MCPTT group for the remotely initiated call;
2. the <request-type> element set to a value of “remotely-initiated-group-call-request”;
3. the <notify-remote-user> element set to a value of “true” if the requesting MCPTT user has indicated that the remote MCPTT user be notified of the remotely initiated group call request; or
4. the <notify-remote-user> element set to a value of “false” if the requesting MCPTT user has indicated that the remote MCPTT user not be notified of the remotely initiated group call request;
5. <remotely-initiated-call-initiator-functional-alias-URI> element set to a value of the functional alias to be used by the remote MCPTT user as an initiator of the call while initiating a call requested by a received remotely initiated MCPTT call request; and
6. <remotely-initiated-call-application-level-priority> element set to a value of the namespace and priority values as specified in IETF RFC 8101 and MCPTT service configuration document (see the service configuration document in 3GPP TS 24.484) to be used by the remote MCPTT user to request an application level priority for a call while initiating a call requested by a received remotely initiated MCPTT call request;

Further MCPTT client shall send the SIP MESSAGE request towards the MCPTT server according to rules and procedures of 3GPP TS 24.229.

Remote client procedures for handling remotely initiated group call request

Upon receiving a “SIP MESSAGE request for remotely initiated group call request for terminating client”, the MCPTT client:
1) shall extract the MCPTT group ID of the identified MCPTT group from the <mcptt-calling-group-id> element contained in the <mcptt-Params> element of the <mcpttinfo> element contained in the application/vnd.3gpp.mcptt-info+xml MIME body contained in the received SIP MESSAGE request and any other actions based on received <notify-remote-user> element;
2) if according to local policy on-demand sessions are to be used for remotely initiated group calls, shall invoke the procedures of clause 10.1.1.2.1.1 of 3GPP TS 24.379 to originate an MCPTT group call to the targeted MCPTT group with the following clarifications:
a) if the <remotely-initiated-call-initiator-functional-alias-URI> element contained in the <anyExt> element of the <mcptt-Params> element of the <mcpttinfo> element contained in the application/vnd.3gpp.mcptt-info+xml MIME body contained in the received SIP MESSAGE request is set to value of functional alias URI, may include in the initial SIP INVITE request as used functional alias (i.e. calling party functional alias), if the received functional alias activated for an MCPTT ID of the identified MCPTT user;
b) if the <remotely-initiated-call-application-level-priority> element contained in the <anyExt> element of the <mcptt-Params> element of the <mcpttinfo> element contained in the application/vnd.3gpp.mcptt-info+xml MIME body contained in the received SIP MESSAGE request is set to a value of the namespace and priority value, may include in the initial SIP INVITE request as a requested resource priority as specified in IETF RFC 8101 and MCPTT service configuration document (see the service configuration document in 3GPP TS 24.484); and
If according to local policy pre-established sessions are to be used for remotely initiated group calls and a pre-established session is available, shall invoke the procedures of clause 10.1.1.2.2.1 of 3GPP TS 24.379 to originate an MCPTT group call to the targeted MCPTT group with the following clarifications:
a) if the <remotely-initiated-call-initiator-functional-alias-URI> element contained in the <anyExt> element of the <mcptt-Params> element of the <mcpttinfo> element contained in the application/vnd.3gpp.mcptt-info+xml MIME body contained in the received SIP MESSAGE request is set to value of functional alias URI, may include in the initial SIP REFER request as used functional alias (i.e. calling party functional alias), if the received functional alias activated for an MCPTT ID of the identified MCPTT user; and
b) if the <remotely-initiated-call-application-level-priority> element contained in the <anyExt> element of the <mcptt-Params> element of the <mcpttinfo> element contained in the application/vnd.3gpp.mcptt-info+xml MIME body contained in the received SIP MESSAGE request is set to a value of the namespace and priority value, may include in the initial SIP REFER request as a requested resource priority as specified in IETF RFC 8101 and MCPTT service configuration document (see the service configuration document in 3GPP TS 24.484).

### Xml Schema:

The XML schema shall include the following new elements.
1. <!--These elements can be added under the anyExt element of the mcpttinfo element-->
2. <xs:element name=“remotely-initiated-call-initiator-functional-alias-URI” type=“mcpttinfo: contentType” minOccurs=“0”/>
3. <xs: element name=“remotely-initiated-call-target-functional-alias-URI” type=“mcpttinfo: contentType” minOccurs=“0”/>
4. <xs: element name=“remotely-initiated-call-application-level-priority” type=“xs: string” minOccurs=“0”/><xs: element name=“remotely-initiated-call-commencement-mode” type=“xs: string” minOccurs=“0”/>

### Semantic:

The <mcpttinfo> element is the root element of the XML document. The <mcpttinfo> element can contain subelements. NOTE 1: The subelements of the <mcpttinfo> are validated by the <xs: any namespace=“##any” processContents=“lax” minOccurs=“0” maxOccurs=“unbounded”/> particle of the <mcpttinfo> element.

If the <mcpttinfo> contains the <mcptt-Params> element then:
1) the <mcptt-access-token>, <mcptt-request-uri>, <mcptt-calling-user-id>, <mcptt-called-party-id>, <mcptt-calling-group-id>, <emergency-ind>, <alert-ind>, <imminentperil-ind>, <originated-by>, <mcptt-client-id>, <functional-alias-URI>, <called-functional-alias-URI>, <non-acknowledged-user>, <remotely-initiated-call-initiator-functional-alias-URI> and <remotely-initiated-call-target-functional-alias-URI> can be included with encrypted content;
2) for each element in 1) that is included with content that is not encrypted:
a) the element has the “type” attribute set to “Normal”;
b) if the element is one of the following elements: <mcptt-request-uri>, <mcptt-calling-user-id>, <mcptt-called-party-id>, <mcptt-calling-group-id>, <originated-by>, <functional-alias-URI>, <called-functional-alias-URI>, <non-acknowledged-user>, <remotely-initiated-call-initiator-functional-alias-URI> or <remotely-initiated-call-target-functional-alias-URI>, then the <mcpttURI> element is
c) if the element is one of the following elements: <mcptt-access-token> or <mcptt-client-id>, then the <mcpttString> element is included; and
d) if the element is one of the following elements: <emergency-ind>, <alert-ind>, <alert-ind-rcvd>, <imminentperil-ind>, or <emergency-ind-rcvd>, then the <mcpttBoolean> element is included;
If the <mcpttinfo> contains the <mcptt-Params> element then:
1) Other elements defined:
2) the <anyExt> can be included with the following elements not declared in the XML schema:
a. a <remotely-initiated-call-initiator-functional-alias-URI> of type “mcpttinfo: contentType” set to a value of the functional alias to be used by the remote MCPTT user as an initiator of the call while initiating a call requested by a received remotely initiated MCPTT call request along with the MCPTTID of the called party (remote);
b. a <remotely-initiated-call-target-functional-alias-URI> of type “mcpttinfo: contentType” set to a value of the functional alias to be used by the remote MCPTT user as a target of the call while initiating a call requested by a received remotely initiated MCPTT call request;
c. a <remotely-initiated-call-application-level-priority> of type “xs: string” set to a value of the namespace and priority values as specified in IETF RFC 8101 and MCPTT service configuration document (see the service configuration document in 3GPP TS 24.484) to be used by the remote MCPTT user to request an application level priority for a call while initiating a call requested by a received remotely initiated MCPTT call request; and
d. a <remotely-initiated-call-commencement-mode> of type “xs: string”:
i) set to a value of “force-auto-mode” to indicate to remote MCPTT user to request the force of automatic commencement mode at the invited MCPTT client while initiating a call requested by a received remotely initiated MCPTT call request;
ii) set to a value of “auto-mode” to indicate to remote MCPTT user to request the automatic commencement mode at the invited MCPTT client while initiating a call requested by a received remotely initiated MCPTT call request; or
iii) set to a value of “manual-mode” to indicate to remote MCPTT user to request the manual commencement mode at the invited MCPTT client while initiating a call requested by a received remotely initiated MCPTT call request.

### MCPTT Client Procedures:

The MCPTT client procedure covers from terminating MCPTT client for receiving remotely initiated MCPTT call request for private call and group call. In the procedures, the term “requesting MCPTT user” is used to refer to the MCPTT user who sent a request to initiate a remotely initiated private call, the term “remote MCPTT user” is used to refer to the MCPTT user who is sent a request to initiate a remotely initiated private call; and, the term “identified MCPTT user” is used to refer to the MCPTT user to be invited to the remotely initiated private call.

### Remote Client Procedures for Handling Remotely Initiated Private Call Request

Upon receiving a “SIP MESSAGE request for remotely initiated private call request for terminating client”, the MCPTT client:
1) shall extract the MCPTT ID of the identified MCPTT user from the <mcptt-called-party-id> element contained in the <anyExt> element of the <mcptt-Params> element of the <mcpttinfo> element contained in the application/vnd.3gpp.mcptt-info+xml MIME body contained in the received SIP MESSAGE request and any other actions based on received <notify-remote-user> element;
2) if according to local policy on-demand sessions are to be used for remotely initiated private calls, shall invoke the procedures of clause 11.1.1.2.1.1 of 3GPP TS 24.379 to originate an MCPTT private call to the identified MCPTT user with the following clarifications:
a) if the <RemotelyInitiatedCallInitiatorFunctionalAliasURI> element exists in the <anyExt> element of the <OnNetwork> element in the MCPTT user profile configuration document with one <entry> element (see the MCPTT user profile configuration document in 3GPP TS 24.484), may include in the initial SIP INVITE request as used functional alias (i.e., calling party functional alias), if the configured functional alias activated for an MCPTT ID of the identified MCPTT user;
b) if the <RemotelyInitiatedCallTargetFunctionalAliasURI> element exists in the <anyExt> element of the <OnNetwork> element in the MCPTT user profile configuration document with one <entry> element (see the MCPTT user profile configuration document in 3GPP TS 24.484), may include in the initial SIP INVITE request as a functional alias to be called (i.e., called party functional alias), if the configured functional alias is authorized to be used by an identified MCPTT user;
c) if the <remotely-initiated-call-application-level-priority> element exists in the <anyExt> element of the <OnNetwork> element in the MCPTT service configuration document (see the MCPTT service configuration document in 3GPP TS 24.484), may include in the initial SIP INVITE request as a requested resource priority as specified in IETF RFC 8101 and MCPTT service configuration document (see the service configuration document in 3GPP TS 24.484); and
d) if the <remotely-initiated-call-commencement-mode> element exists in the <anyExt> element of the <OnNetwork> element in the MCPTT service configuration document (see the MCPTT service configuration document in 3GPP TS 24.484) is set:
i) to value of “force-auto-mode”, may include in the initial SIP INVITE request to privileged answer mode with auto commencement mode to force of automatic commencement mode at the invited MCPTT client;
ii) to value of “auto-mode”, may include in the initial SIP INVITE request to answer mode with auto commencement mode to request automatic commencement mode at the invited MCPTT client; or
iii) to value of “manual-mode”, may include in the initial SIP INVITE request to answer mode with manual commencement mode to request manual commencement mode at the invited MCPTT client; and
If according to local policy pre-established sessions are to be used for remotely initiated private calls and a pre-established session is available, shall invoke the procedures of clause 11.1.1.2.2.1 of 3GPP TS 24.379 to originate an MCPTT private call to the identified MCPTT user with the following clarifications:
a) if the <RemotelyInitiatedCallInitiatorFunctionalAliasURI> element exists in the <anyExt> element of the <OnNetwork> element in the MCPTT user profile configuration document with one <entry> element (see the MCPTT user profile configuration document in 3GPP TS 24.484), may include in the initial SIP REFER request as used functional alias (i.e., calling party functional alias), if the configured functional alias activated for an MCPTT ID of the identified MCPTT user;
b) if the <RemotelyInitiatedCallTargetFunctionalAliasURI> element exists in the <anyExt> element of the <OnNetwork> element in the MCPTT user profile configuration document with one <entry> element (see the MCPTT user profile configuration document in 3GPP TS 24.484), may include in the initial SIP REFER request as a functional alias to be called (i.e., called party functional alias), if the configured functional alias is authorized to be used by an identified MCPTT user;
c) if the <remotely-initiated-call-application-level-priority> element exists in the <anyExt> element of the <OnNetwork> element in the MCPTT service configuration document (see the MCPTT service configuration document in 3GPP TS 24.484), may include in the initial SIP REFER request as a requested resource priority as specified in IETF RFC 8101 and MCPTT service configuration document (see the service configuration document in 3GPP TS 24.484); and
d) if the <remotely-initiated-call-commencement-mode> element exists in the <anyExt> element of the <OnNetwork> element in the MCPTT service configuration document (see the MCPTT service configuration document in 3GPP TS 24.484) is set:
i) to value of “force-auto-mode”, may include in the initial SIP REFER request to privileged answer mode with auto commencement mode to force of automatic commencement mode at the invited MCPTT client;
ii) to value of “auto-mode”, may include in the initial SIP REFER request to answer mode with auto commencement mode to request automatic commencement mode at the invited MCPTT client; or
iii) to value of “manual-mode”, may include in the initial SIP REFER request to answer mode with manual commencement mode to request manual commencement mode at the invited MCPTT client.

Alternatively, the step 2c, 2d and step 3c 3d can be implemented as below:

### Step 2:

a) if the <RemotelyInitiatedCallApplicationLevelPriority> element exists in the <anyExt> element of the <OnNetwork> element in the MCPTT user profile configuration document (see the MCPTT user profile configuration document in 3GPP TS 24.484), may include in the initial SIP INVITE request as a requested resource priority as specified in IETF RFC 8101 and MCPTT service configuration document (see the user profile configuration document in 3GPP TS 24.484); and
b) if the <RemotelyInitiatedCallCommencementMode> element exists in the <anyExt> element of the <OnNetwork> element in the MCPTT user profile configuration document (see the MCPTT user profile configuration document in 3GPP TS 24.484) is set:
i) to value of “force-auto-mode”, may include in the initial SIP INVITE request to privileged answer mode with auto commencement mode to force of automatic commencement mode at the invited MCPTT client;
ii) to value of “auto-mode”, may include in the initial SIP INVITE request to answer mode with auto commencement mode to request automatic commencement mode at the invited MCPTT client; or
iii) to value of “manual-mode”, may include in the initial SIP INVITE request to answer mode with manual commencement mode to request manual commencement mode at the invited MCPTT client; and

### Step 3:

a) if the <RemotelyInitiatedCallApplicationLevelPriority> element exists in the <anyExt> element of the <OnNetwork> element in the MCPTT user profile configuration document (see the MCPTT user profile configuration document in 3GPP TS 24.484), may include in the initial SIP REFER request as a requested resource priority as specified in IETF RFC 8101 and MCPTT service configuration document (see the user profile configuration document in 3GPP TS 24.484); and
b) if the <RemotelyInitiatedCallCommencementMode> element exists in the <anyExt> element of the <OnNetwork> element in the MCPTT user profile configuration document (see the MCPTT user profile configuration document in 3GPP TS 24.484) is set:
i) to value of “force-auto-mode”, may include in the initial SIP REFER request to privileged answer mode with auto commencement mode to force of automatic commencement mode at the invited MCPTT client;
ii) to value of “auto-mode”, may include in the initial SIP REFER request to answer mode with auto commencement mode to request automatic commencement mode at the invited MCPTT client; or
iii) to value of “manual-mode”, may include in the initial SIP REFER request to answer mode with manual commencement mode to request manual commencement mode at the invited MCPTT client.

### Remote Client Procedures for Handling Remotely Initiated Group Call Request:

Upon receiving a “SIP MESSAGE request for remotely initiated group call request for terminating client”, the MCPTT client:
1) shall extract the MCPTT group ID of the identified MCPTT group from the <mcptt-calling-group-id> element contained in the <mcptt-Params> element of the <mcpttinfo> element contained in the application/vnd.3gpp.mcptt-info+xml MIME body contained in the received SIP MESSAGE request and any other actions based on received <notify-remote-user> element;
If according to local policy on-demand sessions are to be used for remotely initiated group calls, shall invoke the procedures of clause 10.1.1.2.1.1 of 3GPP TS 24.379 to originate an MCPTT group call to the targeted MCPTT group with the following clarifications:
a) if the <RemotelyInitiatedCallInitiatorFunctionalAliasURI> element exists in the <anyExt> element of the <OnNetwork> element in the MCPTT user profile configuration document with one <entry> element (see the MCPTT user profile configuration document in 3GPP TS 24.484), may include in the initial SIP INVITE request as used functional alias (i.e. calling party functional alias), if the configured functional alias activated for an MCPTT ID of the identified MCPTT user;
b) if the <remotely-initiated-call-application-level-priority> element exists in the <anyExt> element of the <OnNetwork> element in the MCPTT service configuration document (see the MCPTT service configuration document in 3GPP TS 24.484), may include in the initial SIP INVITE request as a requested resource priority as specified in IETF RFC 8101 and MCPTT service configuration document (see the service configuration document in 3GPP TS 24.484); and
If according to local policy pre-established sessions are to be used for remotely initiated group calls and a pre-established session is available, shall invoke the procedures of clause 10.1.1.2.2.1 of 3GPP TS 24.379 to originate an MCPTT group call to the targeted MCPTT group with the following clarifications:
a) if the <RemotelyInitiatedCallInitiatorFunctionalAliasURI> element exists in the <anyExt> element of the <OnNetwork> element in the MCPTT user profile configuration document with one <entry> element (see the MCPTT user profile configuration document in 3GPP TS 24.484), may include in the initial SIP REFER request as used functional alias (i.e. calling party functional alias), if the configured functional alias activated for an MCPTT ID of the identified MCPTT user; and
b) if the <remotely-initiated-call-application-level-priority> element exists in the <anyExt> element of the <OnNetwork> element in the MCPTT service configuration document (see the MCPTT service configuration document in 3GPP TS 24.484), may include in the initial SIP REFER request as a requested resource priority as specified in IETF RFC 8101 and MCPTT service configuration document (see the service configuration document in 3GPP TS 24.484).

Alternatively, the step 2b and step 3b can be implemented as below:

### Step 2:

a) if the <RemotelyInitiatedCallApplicationLevelPriority> element exists in the <anyExt> element of the <OnNetwork> element in the MCPTT user profile configuration document (see the MCPTT user profile configuration document in 3GPP TS 24.484), may include in the initial SIP INVITE request as a requested resource priority as specified in IETF RFC 8101 and MCPTT service configuration document (see the user profile configuration document in 3GPP TS 24.484); and

### Step 3:

a) if the <RemotelyInitiatedCallApplicationLevelPriority> element exists in the <anyExt> element of the <OnNetwork> element in the MCPTT user profile configuration document (see the MCPTT user profile configuration document in 3GPP TS 24.484), may include in the initial SIP REFER request as a requested resource priority as specified in IETF RFC 8101 and MCPTT service configuration document (see the user profile configuration document in 3GPP TS 24.484); and

### MCPTT User Profile Configuration Document Structure:

The new addition to the MCPTT user profile configuration document structure is specified. The <mcptt-user-profile> document:
1) shall include other required attribute and elements;
2) shall include zero or one <OnNetwork> element which:
a) shall include other required attribute and elements;
b) an <anyExt> element which may contain:
i) shall include other required attribute and elements;
ii) may include one <RemotelyInitiatedCallInitiatorFunctionalAliasURI> element containing an <entry> element;
iii) may include one <RemotelyInitiatedCallTargetFunctionalAliasURI> element containing an <entry> element;

### XML Schema

The XML schema shall include the following new elements. These elements can be added under the anyExt element of the OnNetwork element of mcptt-user-profile root element.
<xs: elementname=“RemotelyInitiatedCallInitiatorFunctionalAliasURI” type=“mcpttup: EntryType” minOccurs=“0”/>
<xs: elementname=“RemotelyInitiatedCallTargetFunctionalAliasURI” type=“mcpttup: EntryType” minOccurs=“0”/>

### Data Semantics

The <uri-entry> element is of type “anyURI” and when it appears within:
a. the <entry> element of the <RemotelyInitiatedCallInitiatorFunctionalAliasURI> element of the <anyExt> element of the <OnNetwork> element contains the functional alias URI to be used as an initiator of the call while initiating a call requested by a received remotely initiated MCPTT call request.
b. the <entry> element of the <Remotely InitiatedCallTargetFunctionalAliasURI> element of the <anyExt> element of the <OnNetwork> element contains the functional alias URI to be used as a target of the call while initiating a call requested by a received remotely initiated MCPTT call request.

### MCPTT Service Configuration Document Structure

The new addition to the MCPTT service configuration document structure is specified. The <service configuration> document:
1) shall include other required attributes and elements;
2) shall include zero or one <OnNetwork> element which:
a) shall include other required attribute and elements;
b) an <anyExt> element which may contain:
i) shall include other required attribute and elements;
ii) may include one <remotely-initiated-call-application-level-priority> string element;
iii) may include one <remotely-initiated-call-commencement-mode> string;

### XML Schema

The XML schema shall include the following new elements. These elements can be added under the anyExt element of the OnNetwork element of service-configuration-info root element.
<xs: element name=“remotely-initiated-call-application-level-priority” type=“xs: string” minOccurs=“0”/>
<!-The values can be: force-auto-mode, auto-mode or manual-mode-->
<xs: element name=“remotely-initiated-call-commencement-mode” type=“xs: string” minOccurs=“0”/>

### Data Semantics

In the <on-network> element:
a. the <remotely-initiated-call-application-level-priority> element of the <anyExt> is of type “string” and set to a value of the namespace and priority values from the resource-priority-namespace and resource-priority-priority elements value as specified in the present document to indicate to request an application level priority for a call while initiating a call requested by a received remotely initiated MCPTT call request.
b. the <remotely-initiated-call-commencement-mode> element of the <anyExt> is of type “string” and set to a value of “force-auto-mode” or “auto-mode” or “manual-mode”, to a value of “force-auto-mode”, to indicate to request the force of automatic commencement mode at the invited MCPTT client while initiating a call requested by a received remotely initiated MCPTT call request, or to a value of “auto-mode”, to indicate to request the automatic commencement mode at the invited MCPTT client while initiating a call requested by a received remotely initiated MCPTT call request, or to a value of “manual-mode”, to indicate to request the manual commencement mode at the invited MCPTT client while initiating a call requested by a received remotely initiated MCPTT call request.

Alternatively, the remotely-initiated-call-application-level-priority and remotely-initiated-call-commencement-mode elements and dependent data can be defined in the MCPTT user profile configuration data as below.

### MCPTT User Profile Configuration Document Structure

The new addition to the MCPTT user profile configuration document structure is specified. The <mcptt-user-profile> document:
1. shall include other required attribute and elements;
2. shall include zero or one <OnNetwork> element which:
a) shall include other required attribute and elements;
b) an <anyExt> element which may contain:
i) shall include other required attribute and elements;
ii) may include one <RemotelyInitiatedCallApplicationLevelPriority> string element;
iii) may include one <RemotelyInitiatedCallCommencementMode> string element.

### XML Schema

The XML schema shall include the following new elements. These elements can be added under the anyExt element of the OnNetwork element of mcptt-user-profile root element.
<xs: element name=“RemotelyInitiatedCallApplicationLevelPriority” type=“xs: string” minOccurs=“0”/>
<!-The values can be: force-auto-mode, auto-mode or manual-mode-->
<xs: element name=“RemotelyInitiatedCallCommencementMode” type=“xs: string” minOccurs=“0”/>

### Data Semantics

the <RemotelyInitiatedCallApplicationLevelPriority> element of the <anyExt> element of <OnNetwork> element is of type “string” and set to a value of the namespace and priority values from the resource-priority-namespace and resource-priority-priority elements value as specified in the present document to indicate to request an application level priority for a call while initiating a call requested by a received remotely initiated MCPTT call request.
the <RemotelyInitiatedCallApplicationLevelPriority> element of the <anyExt> element of <OnNetwork> element is of type “string” and set to a value of “force-auto-mode” or “auto-mode” or “manual-mode”, to a value of “force-auto-mode”, to indicate to request the force of automatic commencement mode at the invited MCPTT client while initiating a call requested by a received remotely initiated MCPTT call request, to a value of “auto-mode”, to indicate to request the automatic commencement mode at the invited MCPTT client while initiating a call requested by a received remotely initiated MCPTT call request, or to a value of “manual-mode”, to indicate to request the manual commencement mode at the invited MCPTT client while initiating a call requested by a received remotely initiated MCPTT call request.

### Implementation Flows for MCPTT Call (Private or Group Call)—Method 1, 2 and 3 as Described Above:

MCPTT client procedures:

Upon receiving a request from an MCPTT user to establish an MCPTT private/group call, the MCPTT client shall generate an initial SIP INVITE/SIP REFER request, with the clarifications given below:

The MCPTT client:
1) shall/may set the required headers and parameters in SIP INVITE/SIP REFR request.
2) shall contain an application/vnd.3gpp.mcptt-info+xml MIME body with the <mcpttinfo> element containing the <mcptt-Params> element:
a) if the call request is a result of receiving of a remotely initiated MCPTT call request, may include <remotely-initiated-call-request-initiator-URI> element set to the MCPTT ID of the authorized user who has requested for remotely initiated MCPTT call request.
b) if the call request is a result of receiving of a remotely initiated MCPTT call request, may include <remotely-initiated-call-request-ind> element set to “true”.

Upon receipt of an initial SIP INVITE request. The MCPTT client:
1) shall/may validate the required headers and parameters in the SIP INVITE request and other validation;
2) if the <remotely-initiated-call-request-ind> element included in the application/vnd.3gpp.mcptt-info+xml MIME body of the incoming SIP INVITE request, may indicate to the MCPTT user that the received call request is a result of receiving of a remotely initiated MCPTT call request;
3) if the <remotely-initiated-call-request-initiator-URI> element included in the application/vnd.3gpp.mcptt-info+xml MIME body of the incoming SIP INVITE request, may display to the MCPTT user the MCPTT ID of the MCPTT user who has requested for remotely initiated MCPTT call request.

### XML Schema

The XML schema shall include the following new elements. These elements can be added under the anyExt element of the mcpttinfo element.
<xs: element name=“remotely-initiated-call-request-ind” type=“mcpttinfo: contentType” minOccurs=“0”/>
<xs: element name=“remotely-initiated-call-request-initiator-URI” type=“mcpttinfo: contentType” minOccurs=“0”/>

### Semantic

The <mcpttinfo> element is the root element of the XML document. The <mcpttinfo> element can contain subelements. NOTE 1: The subelements of the <mcpttinfo> are validated by the <xs: any namespace=“##any” processContents=“lax” minOccurs=“0” maxOccurs=“unbounded”/> particle of the <mcpttinfo> element.

If the <mcpttinfo> contains the <mcptt-Params> element then:
1) the <mcptt-access-token>, <mcptt-request-uri>, <mcptt-calling-user-id>, <mcptt-called-party-id>, <mcptt-calling-group-id>, <emergency-ind>, <alert-ind>, <imminentperil-ind>, <originated-by>, <mcptt-client-id>, <functional-alias-URI>, <called-functional-alias-URI>, <non-acknowledged-user>, <remotely-initiated-call-initiator-functional-alias-URI>, <remotely-initiated-call-target-functional-alias-URI> and <remotely-initiated-call-request-initiator-URI> can be included with encrypted content.
2) for each element in 1) that is included with content that is not encrypted:
a) the element has the “type” attribute set to “Normal”;
b) if the element is one of the following elements: <mcptt-request-uri>, <mcptt-calling-user-id>, <mcptt-called-party-id>, <mcptt-calling-group-id>, <originated-by>, <functional-alias-URI>, <called-functional-alias-URI>, <non-acknowledged-user>, <remotely-initiated-call-initiator-functional-alias-URI>, <remotely-initiated-call-target-functional-alias-URI>, or <remotely-initiated-call-request-initiator-URI>, then the <mcpttURI> element is
c) if the element is one of the following elements: <mcptt-access-token> or <mcptt-client-id>, then the <mcpttString> element is included; and
d) if the element is one of the following elements: <emergency-ind>, <alert-ind>, <alert-ind-rcvd>, <imminentperil-ind>, <emergency-ind-rcvd>, or <remotely-initiated-call-request-ind>, then the <mcpttBoolean> element is included;

If the <mcpttinfo> contains the <mcptt-Params> element then:
1) Other elements defined:
2) the <anyExt> can be included with the following elements not declared in the XML schema:
a) a <remotely-initiated-call-request-initiator-URI> of type “mcpttinfo: contentType” set to a value of the MCPTT ID of the authorized user who has requested for remotely initiated MCPTT call request while initiating a call requested by a received remotely initiated MCPTT call request;
b) a <remotely-initiated-call-request-ind> of type “mcpttinfo: contentType” element set to “true” to indicate that the call request is a result of receiving of a remotely initiated MCPTT call request;

### Pre-Established Session Call

The table 12 describes newly added pre-established session call control specific data fields.

TABLE 12
Pre-established session call control data fields
Remotely initiated MCPTT call request Indication field

| | Field ID | | |
|---|---|---|---|
| Field name | Decimal | Binary | Reference |
| Remotely initiated | 193 | 11000001 | Clause 8.3.3.12 |
| MCPTT call request | | | |
| Initiator MCPTT User | | | |
| Identity | | | |
| Remotely initiated | 194 | 11000010 | Clause 8.3.3.13 |
| MCPTT call request | | | |
| Indication | | | |

The Remotely initiated MCPTT call request Indication field indicates that the call request is a result of receiving of a remotely initiated MCPTT call request. Table 13 describes the coding of the Remotely initiated MCPTT call request Indication field.

TABLE 13
depicts a remotely initiated MCPTT
call request Indication field coding

| | | | |
|---|---|---|---|
| 0 | 1 | 2 | 3 |

0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−+

| | | | |
|---|---|---|---|
| \|Remotely | \|Remotely | \|Remotely | \| |
| \|Initiated call | \|Initiated call | \|Initiated call | \| |
| \|Request | \|Remotely | \|Remotely | \| |
| \|Indication | \|Indication | \|Indication | \| |
| \|field ID value | \|length value | \|value | \| |

+−+−+−+−+−+−+−+−+−+−+−+−+−+−+−+−+−+−+−+−+−+−+−+−+−+−+−+−+−+−+−+−+

The <Remotely initiated MCPTT call request Indication field ID> value is a binary value and shall be set according to table 12. The <Remotely initiated MCPTT call request Indication length> value is a binary value and shall have the value ‘2’ indicating the total length in octets of the <Remotely initiated MCPTT call request Indication> value item. The <Remotely initiated MCPTT call request Indication> value is a 16-bit binary value with the following values.
1. ‘0’ False
2. ‘1’ True
3. All other values are reserved for future use.

### Remotely Initiated MCPTT Call Request Initiator MCPTT User Identity Field

The Remotely initiated MCPTT call request Initiator MCPTT User Identity field contains the MCPTT ID identifying the MCPTT user who has requested for remotely initiated MCPTT call request while initiating a call requested by a received remotely initiated MCPTT call request. Table 14 describes the coding of the Remotely initiated MCPTT call request Initiator MCPTT User Identity field.

TABLE 14
depicts remotely initiated MCPTT call
request Initiator MCPTT User Identity field coding

| | | | |
|---|---|---|---|
| 0 | 1 | 2 | 3 |

0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−+

| \|Remotely | \|Remotely | \|Remotely Initiated call | \| |
|---|---|---|---|
| \|Initiated call | \|Initiated call | \|Request Initiator | \| |
| \|Request | \|Request | \|MCPTT User Identity | \| |
| \|Initiator MCPTT | \|Initiator MCPTT | \| | \| |
| \|User Identity | \|User Identity | \| | \| |
| \|field ID value | \|length value | \| | \| |
| +−+−+−+−+−+−+−+−+−+−+−+−+−+−+−+−+ | | : | |
| : | (Padding) | : | |

+−+−+−+−+−+−+−+−+−+−+−+−+−+−+−+−+−+−+−+−+−+−+−+−+−+−+−+−+−+−+−+−+

The <Remotely initiated MCPTT call request Initiator MCPTT User Identity field ID> value is a binary value and shall be set according to table 12. The <Remotely initiated MCPTT call request Initiator MCPTT User Identity length> value is a binary value indicating the length in octets of the <Remotely initiated MCPTT call request Initiator MCPTT User Identity> value item except padding. The <Remotely initiated MCPTT call request Initiator MCPTT User Identity> value contains the MCPTT ID of the MCPTT user who has requested for remotely initiated MCPTT call request while initiating a call requested by a received remotely initiated MCPTT call request. The <Remotely initiated MCPTT call request Initiator MCPTT User Identity> value shall be coded as specified in the table 15. The MCPTT ID is specified in 3GPP TS 24.379.

TABLE 15
depicts an ABNF syntax of string values of the <Remotely initiated
MCPTT call request Initiator MCPTT User Identity> value
remotely-initiated-call-request-initiator-mcptt-user-identity = URI

If the length of the <Remotely initiated MCPTT call request Initiator MCPTT User Identity> value is not (2+multiple of 4) bytes, the <Remotely initiated MCPTT call request Initiator MCPTT User Identity> value shall be padded to (2+multiple of 4) bytes. The value of the padding bytes should be set to zero. The padding bytes shall be ignored.

### Connect Message

The newly added fields are included in the connect message as defined in the table 16.

TABLE 16
Connect message
Remotely initiated MCPTT call request Indication

| | | | |
|---|---|---|---|
| 0 | 1 | 2 | 3 |

0 1 2 3 4 5 6 7 8 9 0 1 2 3 4 5 6 7 8 9 0 1 2 3 4 5 6 7 8 9 0 1
+−+−+−+−+−+−+−+−+−+−+−+−+−+−+−+−+−+−+−+−+−+−+−+−+−+−+−+−+−+−+−+−+

| | | |
|---|---|---|
| \| | Remotely initiated MCPTT call request Indication field | \| |

+−+−+−+−+−+−+−+−+−+−+−+−+−+−+−+−+−+−+−+−+−+−+−+−+−+−+−+−+−+−+−+−+

| | | |
|---|---|---|
| \| | Remotely initiated MCPTT call request Initiator | \| |
| \| | MCPTT User Identity field | \| |

+−+−+−+−+−+−+−+−+−+−+−+−+−+−+−+−+−+−+−+−+−+−+−+−+−+−+−+−+−+−+−+−+

The Remotely initiated MCPTT call request Indication field is coded as described in clause 8.3.3.12.

### Remotely Initiated MCPTT Call Request Initiator MCPTT User Identity:

The remotely initiated MCPTT call request Initiator MCPTT User Identity field is coded as described in clause 8.3.3.13.

### Call Setup Control Over Pre-Established Session State Machine for the Participating MCPTT Function:

Receive SIP INVITE request (R: SIP INVITE)

Upon receiving a SIP INVITE request from the controlling MCPTT function, if in automatic answer mode, the participating MCPTT function:
1. shall send the Connect message to the invited MCPTT client using the media plane control transport channel defined for this call. The Connect message:
a. if the SIP INVITE request included an “application/vnd.3gpp.mcptt-info+xml” MIME body with the <session-type> element set to a value of “prearranged” or “chat”:
i. may include the content of the <remotely-initiated-call-target-functional-alias-URI> element in the Remotely initiated MCPTT call request Initiator MCPTT User Identity field if included in the SIP INVITE message;
ii. may include the content of the <remotely-initiated-call-request-ind> element in the Remotely initiated MCPTT call request Indication field if included in the SIP INVITE message;
b. if the SIP INVITE request includes an “application/vnd.3gpp.mcptt-info+xml” MIME body with the <session-type> element set to a value of “private”:
i. may include the content of the <remotely-initiated-call-target-functional-alias-URI> element in the Remotely initiated MCPTT call request Initiator MCPTT User Identity field if included in the SIP INVITE message;
ii. may include the content of the <remotely-initiated-call-request-ind> element in the Remotely initiated MCPTT call request Indication field if included in the SIP INVITE message;
   Receive SIP 200 (OK) response to the SIP re-INVITE request (R: 200 OK)

Upon receiving the SIP 200 (OK) response to the SIP re-INVITE request of the pre-established session a call as specified in 3GPP TS 24.379 (call setup with manual answer with pre-established session) the participating MCPTT function:
1. shall send the Connect message to the invited MCPTT client(s) using the media plane control transport channel defined for this call. The Connect message:
a. if the SIP INVITE request included an “application/vnd.3gpp.mcptt-info+xml” MIME body with the <session-type> element set to a value of “prearranged” or “chat”:
i. may include the content of the <remotely-initiated-call-target-functional-alias-URI> element in the Remotely initiated MCPTT call request Initiator MCPTT User Identity field if included in the SIP INVITE message;
ii. may include the content of the <remotely-initiated-call-request-ind> element in the Remotely initiated MCPTT call request Indication field if included in the SIP INVITE message;
b. if the SIP re-INVITE request included an “application/vnd.3gpp.mcptt-info+xml” MIME body with the <session-type> element set to a value of “private”:
i. may include the content of the <remotely-initiated-call-target-functional-alias-URI> element in the Remotely initiated MCPTT call request Initiator MCPTT User Identity field if included in the SIP INVITE message;
ii. may include the content of the <remotely-initiated-call-request-ind> element in the Remotely initiated MCPTT call request Indication field if included in the SIP INVITE message;
   Receive Connect message (R: Connect)

Upon reception of a Connect message, the MCPTT client:
1) if the Remotely initiated MCPTT call request Indication field included in the received Connect message, may indicate to the MCPTT user that the received call request is a result of receiving of a remotely initiated MCPTT call request;
2) if the Remotely initiated MCPTT call request Initiator MCPTT User Identity field included in the received Connect message, may display to the MCPTT user the MCPTT ID of the MCPTT user who has requested for remotely initiated MCPTT call request.

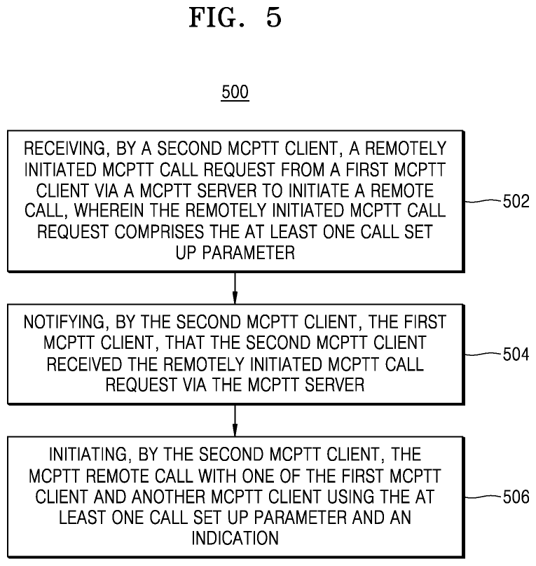

FIG. 5 illustrates a flow diagram depicting a method 500 for handling at least one call set up parameter for a remotely initiated MCPTT call, in accordance with an embodiment of the present subject matter. In an embodiment, the method 500 may be executed by the first MCPTT client, the MCPTT server 104, and the second MCPTT client. Further, for the sake of brevity, details of the present disclosure that are explained in detail in the description of FIG. 1 to FIG. 4 are not explained in detail in the description of FIG. 5.

At block 502, the method 500 includes receiving, by a second MCPTT client, a remotely initiated MCPTT call request from a first MCPTT client via a MCPTT server to initiate a remote call, wherein the remotely initiated MCPTT call request comprises the at least one call set up parameter.

At block 504, the method 500 includes, notifying, by the second MCPTT client, the first MCPTT client, that the second MCPTT client received the remotely initiated MCPTT call request via the MCPTT server.

At block 506, the method 500 includes, initiating, by the second MCPTT client, the MCPTT remote call with one of the first MCPTT client and another MCPTT client using the at least one call set up parameter and an indication.

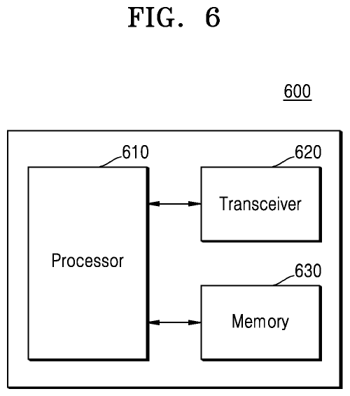

FIG. 6 illustrates a diagram illustrating a MCPTT client 600 according to an embodiment of the present disclosure.

The MCPTT client 600 may be the first MCPTT client, the second MCPTT client or at least one other MCPTT client in this disclosure.

Referring to the FIG. 6, the MCPTT client 600 may include a processor 610, a transceiver 620 and a memory 630. However, all of the illustrated components are not essential. The MCPTT client 600 may be implemented by more or less components than those illustrated in FIG. 6. In addition, the processor 610 and the transceiver 620 and the memory 630 may be implemented as a single chip according to another embodiment.

The aforementioned components will now be described in detail.

The processor 610 may include one or more processors or other processing devices that control the provided function, process, and/or method. Operation of the MCPTT Client in this disclosure may be implemented by the processor 610.

The transceiver 620 may include a RF transmitter for up-converting and amplifying a transmitted signal, and a RF receiver for down-converting a frequency of a received signal. However, according to another embodiment, the transceiver 620 may be implemented by more or less components than those illustrated in components.

The transceiver 620 may be connected to the processor 610 and transmit and/or receive a signal. The signal may include control information and data. In addition, the transceiver 620 may receive the signal through a wireless channel and output the signal to the processor 610. The transceiver 620 may transmit a signal output from the processor 610 through the wireless channel.

The memory 630 may store the control information or the data included in a signal obtained by the MCPTT client 600. The memory 630 may be connected to the processor 610 and store at least one instruction or a protocol or a parameter for the provided function, process, and/or method. The memory 630 may include read-only memory (ROM) and/or random access memory (RAM) and/or hard disk and/or CDROM and/or DVD and/or other storage devices.

While specific language has been used to describe the present disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1.-15. (canceled)

16. A method performed by a first Mission Critical Push-To-Talk (MCPTT) client, the method comprising:
receiving a remotely initiated MCPTT call request from a MCPTT server which receives the a remotely initiated MCPTT call request from a second MCPTT client, wherein the remotely initiated MCPTT call request comprises one or more call set up parameters including at least one of information associated with a commencement mode or information associated with a priority; and
initiating a MCPTT call with at least one of the second MCPTT client or a third MCPTT client using at least one of the one or more call set up parameters or indication information indicating whether a call initiation is due to the receiving of the remotely initiated MCPTT call request.

17. The method of claim 16, wherein the initiating of the MCPTT call comprises sending, to the MCPTT server, a group call request including the indication information indicating that the group call request is a result of the receiving of the remotely initiated MCPTT call request.

18. The method of claim 16, wherein the initiating of the MCPTT call comprises sending, to the MCPTT server, a MCPTT private call request including the indication information indicating that the MCPTT private call request is a result of the receiving of the remotely initiated MCPTT call request.

19. The method of claim 16, wherein the MCPTT server is configured to:
verify whether the second MCPTT client is authorized to initiate the remotely initiated MCPTT call request, and
transmit the remotely initiated MCPTT call request to the first MCPTT client based on the second MCPTT client being authorized.

20. The method of claim 16, further comprising transmitting a remotely initiated MCPTT call response to the MCPTT server based on the receiving of the remotely initiated MCPTT call request, and
wherein the MCPTT server is configured to transmit the remotely initiated MCPTT call response to the second MCPTT client.

21. A first Mission Critical Push-To-Talk (MCPTT) client comprising:
a memory;
a transceiver; and
at least one processor coupled with the transceiver,
wherein the at least one processor is configured to:
receive a remotely initiated MCPTT call request from a MCPTT server which receives the a remotely initiated MCPTT call request from a second MCPTT client, wherein the remotely initiated MCPTT call request comprises one or more call set up parameters including at least one of information associated with a commencement mode or information associated with a priority, and
initiate a MCPTT call with at least one of the second MCPTT client or a third MCPTT client using at least one of the one or more call set up parameters or indication information indicating whether a call initiation is due to receiving of the remotely initiated MCPTT call request.

22. The first MCPTT client of claim 21, wherein at least one processor is further configured to send, to the MCPTT server, a group call request including the indication information indicating that the group call request is a result of the receiving of the remotely initiated MCPTT call request.

23. The first MCPTT client of claim 21, wherein at least one processor is further configured to send, to the MCPTT server, a MCPTT private call request including the indication information indicating that the MCPTT private call request is a result of the receiving of the remotely initiated MCPTT call request.

24. The first MCPTT client of claim 21, wherein the MCPTT server is configured to:
verify whether the second MCPTT client is authorized to initiate the remotely initiated MCPTT call request, and
transmit the remotely initiated MCPTT call request to the first MCPTT client based on the second MCPTT client being authorized.

25. The first MCPTT client of claim 21, wherein at least one processor is further configured to transmit a remotely initiated MCPTT call response to the MCPTT server based on the receiving of the remotely initiated MCPTT call request, and
wherein the MCPTT server is configured to transmit the remotely initiated MCPTT call response to the second MCPTT client.

26. A method performed by a Mission Critical Push-To-Talk (MCPTT) server, the method comprising:
receiving a remotely initiated MCPTT call request from a first MCPTT client, wherein the remotely initiated MCPTT call request comprises one or more call set up parameters including at least one of information associated with a commencement mode or information associated with a priority; and
transmitting the remotely initiated MCPTT call request to a second MCPTT client,
wherein the second MCPTT client initiates a MCPTT call with at least one of the first MCPTT client or a third MCPTT client using at least one of the one or more call set up parameters or indication information indicating whether a call initiation is due to receiving of the remotely initiated MCPTT call request.

27. The method of claim 26, further comprising receiving, from the second MCPTT client, a group call request including the indication information indicating that the group call request is a result of the receiving of the remotely initiated MCPTT call request.

28. The method of claim 26, further comprising receiving, from the second MCPTT client, a MCPTT private call request including the indication information indicating that the MCPTT private call request is a result of the receiving of the remotely initiated MCPTT call request.

29. The method of claim 26, further comprising:
verifying whether the first MCPTT client is authorized to initiate the remotely initiated MCPTT call request; and
transmitting the remotely initiated MCPTT call request to the second MCPTT client based on the first MCPTT client being authorized.

30. The method of claim 26, further comprising:
receiving a remotely initiated MCPTT call response from the second MCPTT client based on the transmitting of the remotely initiated MCPTT call request; and
transmitting the remotely initiated MCPTT call response to the first MCPTT client.
